(19) United States
(12) Patent Application Publication
(10) Pub. No.: US 2025/0367048 A1
(43) Pub. Date: Dec. 4, 2025

(54) ADJUSTABLE BED COVER LIFT AND METHOD OF USE

(71) Applicant: Meleah Hosea, Ribera, NM (US)

(72) Inventor: Meleah Hosea, Ribera, NM (US)

(21) Appl. No.: 18/676,999

(22) Filed: May 29, 2024

(51) Int. Cl. A61G 7/05

(52) U.S. Cl. CPC A61G 7/0501

(57) ABSTRACT

An apparatus and method of use of an adjustable cover lift to be used when an individual is lying in bed. The adjustable cover lift apparatus has a top section, two side sections, and two base sections. The base sections of the adjustable cover lift apparatus are designed to be placed under a mattress, and the top section sits above an individual in bed. A blanket or other covering is placed over the individual and the top section of the adjustable cover lift apparatus, thus raising the blanket or other covering off the individual in the desired area(s).

### TECHNICAL FIELD

The present invention is directed to bed covers, and more particularly to an adjustable bed cover lift.

### BACKGROUND ART

The prior art has an abundance of adjustable frames for any number of uses. Many of these frames are difficult to use and have very specific functions. U.S. Pat. No. 8,804,321B2 entitled “Bed-tent” to Danaher provides a bed tent that is an enclosure over a mattress. U.S. Pat. No. 4,590,956A titled “Bed Tent” to Griesenbeck similarly provides a bed tent that fits over a mattress. U.S. Pat. No. 1,608,242A titled “Folding portable canopy frame” to Sava provides a canopy frame. U.S. Pat. No. 6,357,510B1 titled “Collapsible support frames” to Zheng provides foldable frame members that can support panel pieces, objects, and coverings, amount other things. U.S. Pat. No. 8,804,321B2 titled “Work and videoconference assembly” to Kincaid et al. provides a support frame that comprises a workspace configuration.

The present invention provides an adjustable lift that allows covers on a bed to be suspended above an individual on any given body part. This is particularly important for individuals who have had surgery and do not want the pressure on the affected body part. The present invention would be placed directly over the affected body part, and the covers (blankets, sheets, etc.) are placed on top of the individual and the present invention. This allows an individual to still use covers, while maintaining comfort by keeping the covers off a desired body part. The prior art is lacking for adjustable frames that fit on a bed and are designed to hold a cover or sheet above an individual.

The present invention overcomes the shortcomings contained in the prior art by providing a system and method that is adjustable, easy to use, comfortable, and sturdy, and provides the desired result of allowing an individual to be covered while sleeping, while having the sheets and/or other coverings not directly on a desired body part/area.

None of the prior art fully addresses the problems resolved by the present invention. The present invention overcomes these limitations contained in the prior art.

Certain embodiments of the invention have other steps or elements in addition to or in place of those mentioned above. The steps or element will become apparent to those skilled in the art from a reading of the following detailed description when taken with reference to the accompanying figures, if any.

### BRIEF DESCRIPTION OF THE DRAWINGS

FIG. 1 is a perspective view of the cover lift of the present invention.

FIG. 2 is a front view of the cover lift of the present invention.

FIG. 3 is a top down view of the cover lift of the present invention.

FIG. 4 is a side view of the cover lift of the present invention.

FIG. 5 is an exploded view of the cover lift of the present invention.

FIG. 6 is a perspective view of the cover lift of the present invention in use on a bed.

### DETAILED DESCRIPTION OF THE INVENTION

The best mode for carrying out the invention will be described herein. The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. To avoid obscuring the present invention, some well-known system configurations, and process steps are not disclosed in detail. The figures illustrating embodiments of the system, if any, are semi-diagrammatic and not to scale and, particularly, some of the dimensions are for the clarity of presentation and are shown exaggerated in the drawing figures.

Alternate embodiments have been included throughout, and the order of such are not intended to have any other significance or provide limitations for the present invention.

The words “including”, “comprising”, “incorporating”, “consisting of”, “have”, and “is” are meant to be non-exclusive, meaning additional items, components or elements may be present. Joinder references such as “connected”, “connecting”, “attached”, and “coupled” do not limit the position, orientation, or use of systems and/or methods, and do not necessarily infer that two elements are directly connected. All identifying numerical terms are for identification only, and do not refer to the order or preference of any element, embodiment, variation and/or modification.

All references to “a” and “an”, as in “a member”, mean “one or more”. All references to cover, covering, blanket, sheet, etc., comprise any possible item that is meant or desired to be placed on top of the cover lift, as intended, and the use of any of those words is not intended to limit the items.

The present disclosure provides a cover lift designed to be used when an individual is lying in bed. The cover lift has base sections which are designed to fit under the mattress. The cover lift can be adjusted to be placed over a desired area of an individual when laying down. All parts of the cover lift are adjustable. The side sections are adjusted to allow the base sections to fit below the mattress, with the top section to be above the mattress.

The present invention provides a bed cover lift apparatus comprising: a top section; two side sections; and two base sections, wherein the sections each include a plurality of members with varying lengths, wherein the members are connected to corresponding parallel members with one or more crossmembers, wherein the members on the top section and two side sections are slidably coupled to other members via telescopic tubes with spring button locks and corresponding holes, wherein the crossmembers are slidably coupled to other crossmembers via telescopic tubes with spring button locks and corresponding holes, wherein the two side sections are each attached to the distal ends of the top section at 90 degree angles, and wherein the two base sections are each attached to the distal ends of the side sections at 90 degree angles.

The present invention further provides a bed cover lift apparatus, wherein the two base sections are arranged such that they extend directly under the top section; wherein the members two bottom sections are slidably coupled to other members via telescopic tubes with spring button locks and corresponding holes; wherein the members are coupled to other members via other connection means; wherein crossmembers are located at the distal ends of the top section, side sections, and the base sections; wherein connectors connect the various crossmembers to the members; and wherein the member and crossmembers are each one piece.

The present invention further provides a method of using a bed cover lift apparatus, the method comprising: adjusting the length of a top section of the bed cover lift such that the top section is slightly wider than a mattress; adjusting the width of the top section of the bed cover lift as desired; adjusting the length of side portions of the bed cover lift such that the bed cover lift can be placed under the mattress while still allowing room for a person to lay between the mattress and the bed cover lift; placing base sections of the bed cover lift securely under the mattress at a location as to allow a blanket or other covering to be lifted above a desired body part; and placing a blanket or other covering over the bed cover lift.

The present invention further provides a method of using a bed cover lift apparatus, wherein the crossmembers are slidably coupled to other crossmembers via telescopic tubes with spring button locks and corresponding holes, and the members are slidably coupled to other members via telescopic tubes with spring button locks and corresponding holes; wherein the members and crossmembers are adjusted by pushing in the spring button locks and sliding the member or crossmember into the corresponding member or crossmember such that the spring button lock goes into the desired hole, thus securing the members or crossmembers.

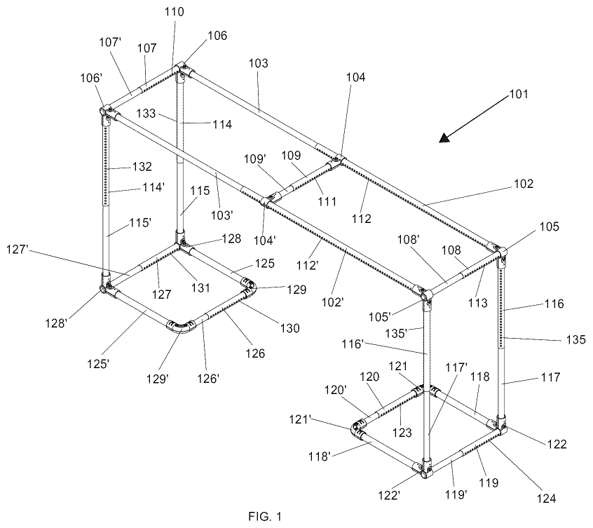

FIG. 1 illustrates a perspective view of cover lift 101. Members 103 and 103′ are slidably coupled to members 102 and 102′, respectively. Members 114 and 114′ are slidably coupled to members 115 and 115′, respectively. Members 116 and 116′ are slidably coupled to members 1117 and 117′, respectively. Members 127 and 127′ are slidably coupled. Members 126 and 126′ are slidably coupled. Members 120 and 120′ are slidably coupled. Members 119 and 119′ are slidably coupled. Crossmembers 107 and 107′ are slidably coupled. Crossmembers 109 and 109′ are slidably coupled. Crossmembers 108 and 108′ are slidably coupled.

Crossmembers and members may be used interchangeably and are similar pieces, except that references to crossmembers denote they are at 90 degree angles from the members, and they connect two corresponding members.

Members and crossmembers that are slidably coupled are telescopic tubes such that one member or one crossmember slides into the corresponding member or crossmember. The member or crossmember that slides into the corresponding member or crossmember has a spring button lock, while the receiving member has holes. Holes 111, 112, 112′, 113, 110, 135, 135′ (edge of holes shown in FIG. 1), 124, 123, 130, 131, 132, 133 are shown. Any number of holes may be present on any of the members and crossmembers. All members and crossmembers that contain holes are slightly larger in diameter than their corresponding member or crossmember that slidably attaches into the member or crossmember with holes. The members and crossmembers that do not contain holes that have a corresponding member or crossmember with holes contain one or more spring button locks, which act to fit into the holes when the members or crossmembers are slidably connected. The spring button locks act such that they are able to be pushed down to allow the member or crossmember to slide into the corresponding member or crossmember that contains the holes. Once the member or crossmember slides into alignment with a hole, the spring button lock pops into the hole, thus securably attaching the two members or crossmembers.

The members and crossmembers may be switched as to which one contains the holes and the spring button locks. Additionally, any number of the members and crossmembers may not have holes and corresponding spring button locks.

While the preferred embodiment of the present invention comprises the use of holes and spring button locks to slidably attach/connect the members and crossmember, other means of securably or slidably attaching members and crossmembers together may be utilized.

Any number of members or crossmembers may be present in the present invention, with members or crossmembers added or deleted. Other elements may be present as well.

Three way connectors 106 and 106′ connect members 103, 114, and crossmember 107, and members 103′, 114′, and crossmember 107′, respectively. Three way connectors 105 and 105′ connect members 102, 116, and crossmember 108, and members 102′, 116′, and crossmember 108′, respectively. Three way connectors 128 and 128′ connect members 125, 115, and crossmember 127, and members 125′, 115′, and crossmember 127′, respectively. Three way connectors 122 and 122′ connect members 117, 118, and crossmember 119, and members 117′, 118′, and crossmember 119′, respectively.

Connectors 104 and 104′ are slidably attached to members 102 and 102′, respectively, and securely attached to crossmembers 109 and 109′, respectively.

Connectors 121, 121′, 129, and 129′ are two way connectors that securably connect members 118 and 120, members 120′ and 118′, members 125 and 126, and members 126′ and 125′, respectively.

Connectors may comprise any method of securably or slidably attaching members.

The present invention may comprise any number of members, connectors, cross members, in any combination, including the addition of other elements or types of connectors, member, or crossmembers. Although the members and crossmembers in the preferred embodiment are slidably coupled, they may be coupled in any other appropriate manner. Additionally, member and crossmember may not be adjustable in some embodiments and instead are single pieces.

All members and crossmembers may be tubular or any other shape and/or size that is suitable for the desired use. All members and crossmembers may be comprised of any materials, in any shape, size, diameters, lengths, etc.

Any of the members, crossmembers, and other elements of cover lift 101 may be removed, combined, replaced, etc.

The top section of cover lift 101 comprises crossmembers 107, 107′, 109, 109′, 108, and 108′. The top section of cover lift 101 further comprises members 102, 102′, 103, and 103′. The members and crossmembers are secured using the three way connecters 105, 105, 106, and 106, and the slidable connectors 104 and 104′.

The side sections of cover lift 101 comprise members 116, 116′, 117, 117′, 114, 114′, 115, and 115′. The side sections attach to the distal ends of the top section via three way connecters 105, 105, 106, and 106. Side sections attach to top section at 90 degree angles.

The base sections of cover lift 101 comprise crossmembers 127, 127′, 126, 126′, 120, 120′, 119, and 119′. The base sections of cover lift 101 further comprise member 118, 118′, 125, and 125′. The base sections attach to the distal ends of the side sections via three way connector 128, 128′, 122, and 122′. Connectors 129, 129′, 121, and 121′ are connected to crossmembers 126, 126′, 120, and 120′, respectively. Base section attaches to side sections at 90 degree angles, such that the base section extends directly below the top section.

Although the preferred embodiment comprises the side sections attaching to the top section at 90 degree angles, and the base sections attaching to the side sections at 90 degree angles, other angles and configurations may be utilized.

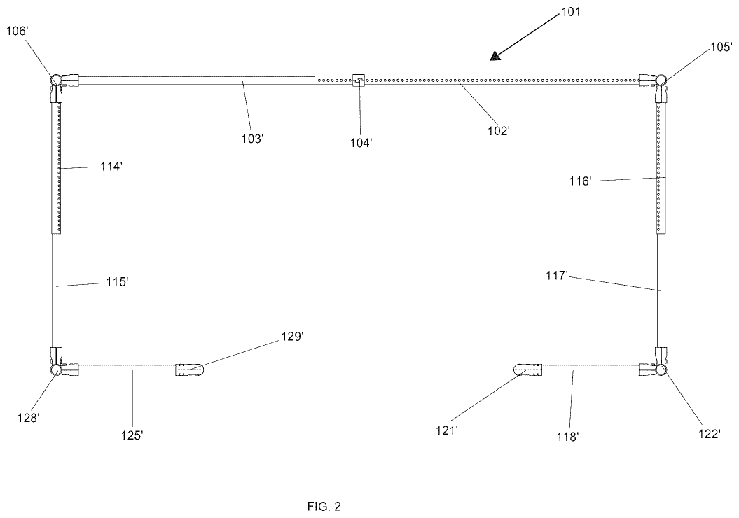

FIG. 2 illustrates a front view of cover lift 101. Cover lift 101 can solidly stand on its own using base section, with members 118′ and 125′ show in this figure.

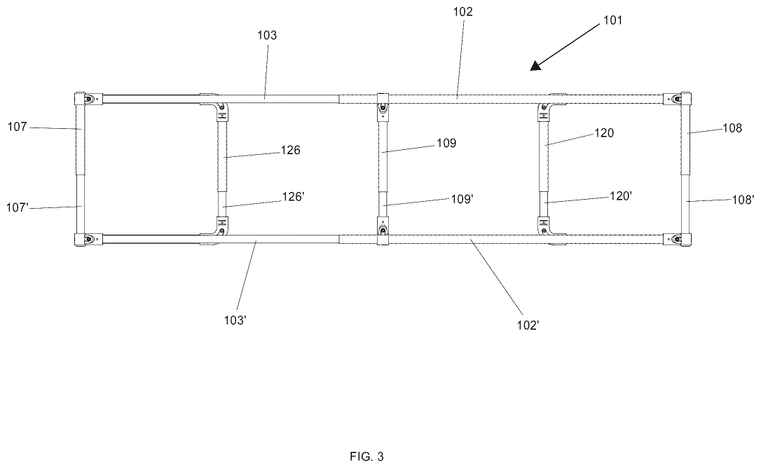

FIG. 3 illustrates a top down view of cover lift 101.

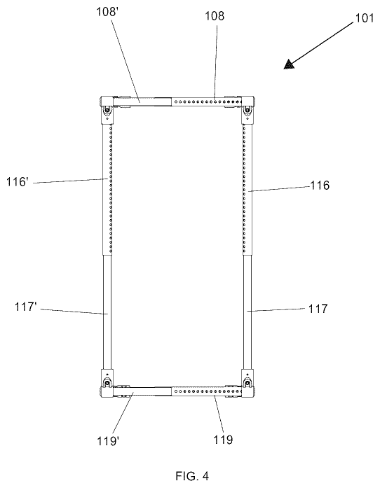

FIG. 4 illustrates a side view of cover lift 101.

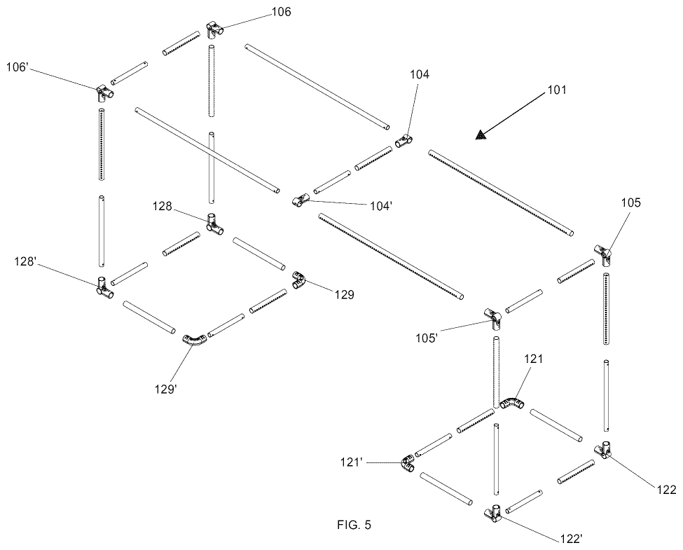

FIG. 5 illustrates an exploded view of cover lift 101. In this figure, the various connections have been numbered. All the members/crossmembers and their corresponding members/crossmembers have been separated.

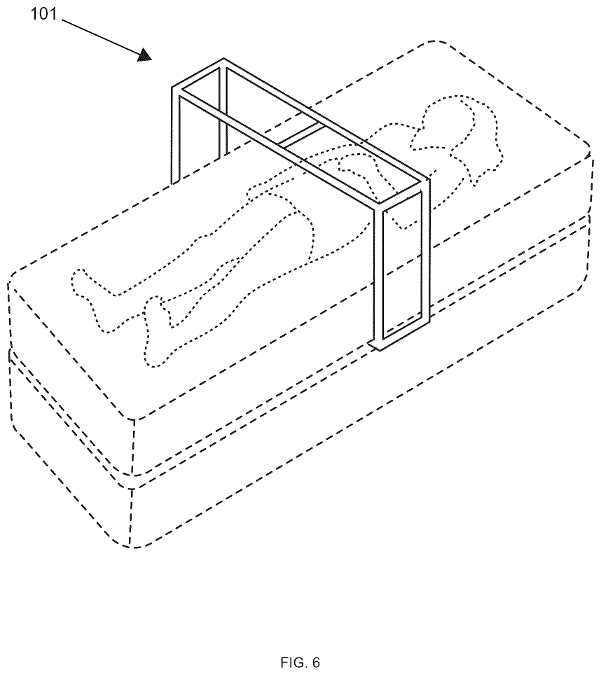

FIG. 6 illustrates a perspective view of cover lift 101 in use on a bed. In this figure, cover lift 101 is simplified as to not show any of the joints, separate member/crossmember, holes, or other elements. FIG. 6 is meant to simply show how the base sections of cover lift 101 fit below a mattress, thus allowing the top section of cover lift 101 to be above an individual laying down. A blanket or other covering can then be placed over the individual, and cover lift 101 keeps pressure off the individual in a desired area. The weight of the mattress acts to hold the cover lift 101 in place.

Although FIG. 6 is a simplified view of cover lift 101, in some embodiments, members and crossmembers may comprise each one piece, or the entirety of cover lift 101 may be one solid piece. In these embodiments, cover lift 101 is not adjustable.

Cover lift 101 is adjustable in virtually all directions.

Additional members, crossmembers, and/or other elements may be added or removed as desired, as well as combined with other elements.

Although the preferred embodiment utilizes cover lift 101 to be used by an individual while in bed, cover lift 101 may be used in any number of other areas, with or without a bed. Additionally, the base sections of cover lift 101 may be placed directly on the floor instead of below the mattress. The cover lift 101 may be used for other sleeping arrangements that do not include a mattress, including, but not limited to, sleeping on the floor, sleeping on a couch, etc., in which for at least most of these instances the base sections of cover lift 101 would be placed on the floor.

The present invention overcomes the shortcomings contained in the prior art by providing an adjustable, easy to use apparatus that allows for covers to be lifted off an individual in a desired location.

Additional elements and/or steps may be added or removed to the present invention, as desired.

In alternate embodiments, any of the top section, side sections, and base sections may comprise solid pieces, or other elements, to fill the space created by the members and crossmembers. As far as the top section, this would create a table top. This could add to privacy for the two side sections, and a more secure base for the two base sections.

Although references have been made to one top, two side sections, and two base sections, any number of each of these may be present in cover lift 101, as may be desired by the user. As such, there could be more than two base sections, or the base sections could be simple legs without crossmembers.

The best mode for carrying out the invention has been described herein. The previous embodiments are described in sufficient detail to enable those skilled in the art to make and use the invention. It is to be understood that other embodiments would be evident based on the present disclosure, and that system, process, or mechanical changes may be made without departing from the scope of the present invention.

In the previous description, numerous specific details and examples are given to provide a thorough understanding of the invention. However, it will be apparent that the invention may be practiced without these specific details and specific examples. While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters previously set forth herein or shown in the accompanying figures are to be interpreted in an illustrative and non-limiting sense.

What is claimed is:

1. A bed cover lift apparatus comprising:
a top section;
two side sections; and
two base sections,
wherein the sections each include a plurality of members with varying lengths,
wherein the members are connected to corresponding parallel members with one or more crossmembers,
wherein the members on the top section and two side sections are slidably coupled to other members via telescopic tubes with spring button locks and corresponding holes,
wherein the crossmembers are slidably coupled to other crossmembers via telescopic tubes with spring button locks and corresponding holes,
wherein the two side sections are each attached to the distal ends of the top section at 90 degree angles, and
wherein the two base sections are each attached to the distal ends of the side sections at 90 degree angles.

2. The bed cover lift apparatus of claim 1, wherein the two base sections are arranged such that they extend directly under the top section.

3. The bed cover lift apparatus of claim 1, wherein the members two bottom sections are slidably coupled to other members via telescopic tubes with spring button locks and corresponding holes.

4. The bed cover lift apparatus of claim 1, wherein the members are coupled to other members via other connection means.

5. The bed cover lift apparatus of claim 1, wherein crossmembers are located at the distal ends of the top section, side sections, and the base sections.

6. The bed cover lift apparatus of claim 1, wherein connectors connect the various crossmembers to the members.

7. The bed cover lift apparatus of claim 1, wherein the member and crossmembers are each one piece.

8. A method of using a bed cover lift apparatus, the method comprising:
adjusting the length of a top section of the bed cover lift such that the top section is slightly wider than a mattress;
adjusting the width of the top section of the bed cover lift as desired;
adjusting the length of side portions of the bed cover lift such that the bed cover lift can be placed under the mattress while still allowing room for a person to lay between the mattress and the bed cover lift;
placing base sections of the bed cover lift securely under the mattress at a location as to allow a blanket or other covering to be lifted above a desired body part; and
placing a blanket or other covering over the bed cover lift.

9. The method of using a bed cover lift apparatus of claim 8, wherein the crossmembers are slidably coupled to other crossmembers via telescopic tubes with spring button locks and corresponding holes, and the members are slidably coupled to other members via telescopic tubes with spring button locks and corresponding holes.

10. The method of using a bed cover lift apparatus of claim 9, wherein the members and crossmembers are adjusted by pushing in the spring button locks and sliding the member or crossmember into the corresponding member or crossmember such that the spring button lock goes into the desired hole, thus securing the members or crossmembers.
